(19) United States
(12) Patent Application Publication
(10) Pub. No.: US 2023/0066214 A1
(43) Pub. Date: Mar. 2, 2023

(54) HIVE-MOUNTED VAPORIZER ADAPTER PLATE

(71) Applicant: Robert Earl Pollock, IV, Baltimore, MD (US)

(72) Inventor: Robert Earl Pollock, IV, Baltimore, MD (US)

(21) Appl. No.: 17/411,121

(22) Filed: Aug. 25, 2021

(51) Int. Cl. A01K 55/00; A01K 51/00; A01K 47/06

(52) U.S. Cl. CPC A01K 55/00; A01K 51/00; A01K 47/06

(57) ABSTRACT

Disclosed is a vaporizer adapter device for a beekeeping device. The adapter device includes an adapter body (e.g., a flat plate) having at least one hive engagement feature (e.g., side edges of the plate); at least one manipulation feature (e.g., a lip for gripping a front of the plate); and a recess for providing a reservoir (e.g., a space for the hot acid vapor to gather) below the hive, the reservoir being open to an interior of the hive, the recess including a port (e.g., a through hole) configured to accommodate a vaporizer output (e.g., a tube) of a vaporizer.

### FIELD OF THE INVENTION

The present general inventive concept relates to adapter plates, and more particularly to hive-mounted adapter plates configured to protect hives from hot vapor treatments.

### BACKGROUND OF THE INVENTION

Beekeeping devices such as artificial beehives, bee boxes, and the like required treatment to kill varroa mites. The treatment is typically accomplished by using an external vaporizer to heat oxalic acid to a vapor and directing the acid vapor into the beekeeping device. The acid vapors kill the varroa mites.

Such beekeeping devices are typically made of wood or plastic. The wooden beekeeping devices are not adversely affected by the hot stem of the vaporizer output. However, plastic beekeeping devices will melt or singe.

Therefore, there is a need for enabling use of an oxalic acid vaporizer with plastic beekeeping devices.

### SUMMARY OF THE INVENTION

Certain of the foregoing and related aspects are readily attained according to the present general inventive concept by providing a hive-mounted adapter plate configured to protect hives from hot vapor treatments.

In example embodiments of the present general inventive concept, the invention provides a vaporizer adapter device for a beekeeping device. The adapter device includes an adapter body (e.g., a flat plate) having at least one hive engagement feature (e.g., side edges of the plate); at least one manipulation feature (e.g., a lip for gripping a front of the plate); and a recess for providing a reservoir (e.g., a space for the hot acid vapor to gather) below the hive, the reservoir being open to an interior of the hive, the recess including a port (e.g., a through hole) configured to accommodate a vaporizer output (e.g., a tube) of a vaporizer.

In example embodiments, the hive has lateral protrusions (e.g., ledges), and the hive engagement feature includes lateral edges that slidably engage with the protrusions. The protrusions extend inwardly (e.g., ledges extending inwardly from interior walls of the hive bottom), and the edges slide on the protrusions (e.g., the plate edges slide along the ledges to support the plate when installed). Further, the adapter body is planar, the edges extend non-parallel to the adapter body (e.g., bend downward relative to the body of the plate), and ends of the edges (e.g., downwardly extending ends of the edges) slide on the protrusions.

In example embodiments, the manipulation feature includes a lip that extends outwardly from the hive (e.g., is outside the hive) when the device is installed in the hive. The adapter body is planar and the lip extends non-parallel to the body (e.g., bends upwards and away from the body of the plate).

In example embodiments, the reservoir has a pyramid shape with a base of the pyramid shape being open to the interior of the hive. The pyramid shape is a triangular pyramid shape. The base of the triangular pyramid shape is an isosceles triangle. However, the present general inventive concept is not limited thereto.

In example embodiments, the port includes a hole (e.g., a through hole) leading from an exterior surface of the recess to an interior surface of the recess.

In operation, the vaporizer adapter device is installed by engaging the hive engagement feature of the adapter body with the hive using the hive manipulating feature to install the vaporizer adapter device in the hive such that the reservoir is open to an interior of the hive. Then, a vaporizer output of a vaporizer is passed through the port and the vaporizer is operated to apply the treatment such that the hot acid vapors gather in the reservoir and pass into the interior of the hive, killing any varroa mites.

As an example operation, the vaporizer adapter device is installed by sliding the lateral edges of the adapter plate onto the lateral protrusions of the hive using the lip of the adapter plate to install the vaporizer adapter device in the hive at the hive bottom such that the reservoir is open from above to an interior of the hive. Then, a vaporizer output of a vaporizer is passed through the port and the vaporizer is operated to apply the treatment such that the hot acid vapors gather in the reservoir and then pass upwardly into the interior of the hive, killing any varroa mites.

In other example embodiments of the present general inventive concept, the invention provides a beekeeping device that includes a hive body and a vaporizer adapter device of a type discussed above.

It should be understood that the vaporizer adapter device can be a separate device that is installed in the beekeeping device or otherwise cooperates with the hive, but can alternatively be in whole or in part integrated into the beekeeping device.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view of a beekeeping hive with a vaporizer adapter plate according to an example of the present general inventive concept installed in the hive.

FIG. 2 is a front upside-down perspective view of the vaporizer adapter plate of FIG. 1.

FIG. 3 is a front upside-down view of the vaporizer adapter plate of FIG. 1;

FIG. 4 is a back upside-down view of the vaporizer adapter plate of FIG. 1;

FIG. 5 is a bottom view of the vaporizer adapter plate of FIG. 1;

FIG. 6 is a top view of the vaporizer adapter plate of FIG. 1;

FIG. 7 is a schematic representation view of the vaporizer adapter plate of FIG. 1;

FIG. 8 is a bottom left side perspective partial assembly view of the vaporizer adapter plate of FIG. 1;

FIG. 9 is a bottom right side perspective partial view of the vaporizer adapter plate of FIG. 1.

FIG. 10 is a bottom left side perspective partial view of the vaporizer adapter plate of FIG. 1.

FIG. 11 is a bottom perspective view of the vaporizer adapter plate of FIG. 1.

FIG. 12 is a front perspective view of the beekeeping hive of FIG. 1 with the vaporizer adapter plate of FIG. 1 installed in the hive.

FIG. 13 is a front perspective view of the beekeeping hive of FIG. 1 with the vaporizer adapter plate of FIG. 1 partially installed in the hive.

FIG. 14 is a side perspective view of the beekeeping hive of FIG. 1 with the vaporizer adapter plate of FIG. 1 partially installed in the hive.

FIG. 15 is a front perspective view of the beekeeping hive of FIG. 1 with the vaporizer adapter plate of FIG. 1 powder coated and installed in the hive.

FIG. 16 is a front perspective view of the beekeeping hive of FIG. 1 with the vaporizer adapter plate of FIG. 1 powder coated and partially installed in the hive.

FIG. 17 is a side perspective view of a vaporizer for a beekeeping hive.

FIG. 18 is a front perspective view of the beekeeping hive of FIG. 1 with the vaporizer adapter plate of FIG. 1 powder coated and installed in the hive, with the vaporizer of FIG. 17 with its vaporizer output fitted within a port of the vaporizer adapter plate.

### DESCRIPTION OF EXAMPLE EMBODIMENTS

The present inventive concept will now be described more fully with reference to the accompanying drawings, in which exemplary embodiments of the present general inventive concept are illustrated. The inventive concept may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals refer to like elements throughout.

### Vaporizer Adapted Device Embodiments

In example embodiments of the present general inventive concept, the invention provides a vaporizer adapter device for a beekeeping device. While the present general inventive concept can be used with any beekeeping device, typically beekeeping devices are artificial beehives, bee boxes, and the like.

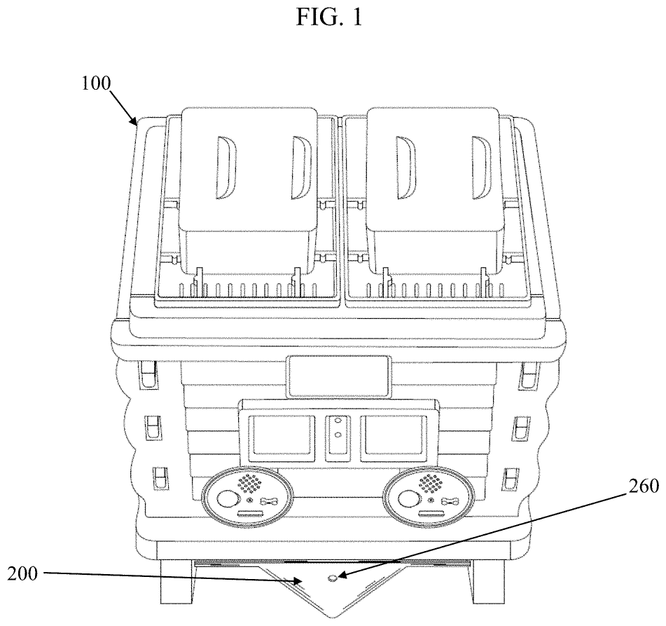

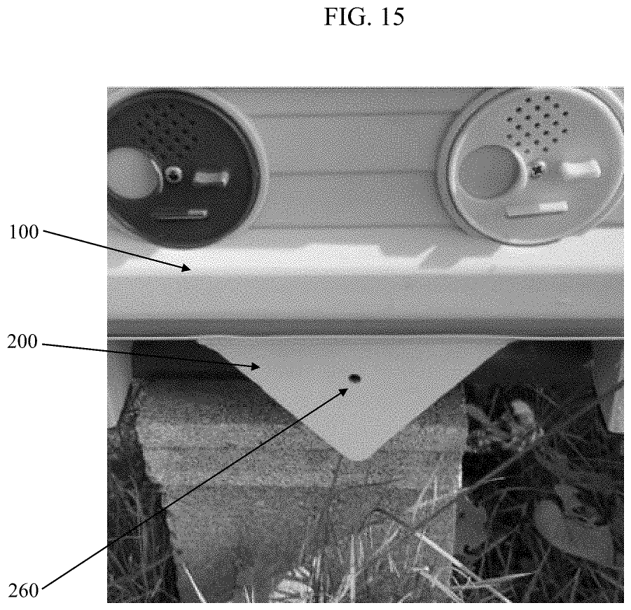

Referring now to FIGS. 1, 12, 15 and 18, an example embodiment of a vaporizer adapter device 200, for a beekeeping hive 100, according to the present general inventive concept is illustrated installed in the hive 100.

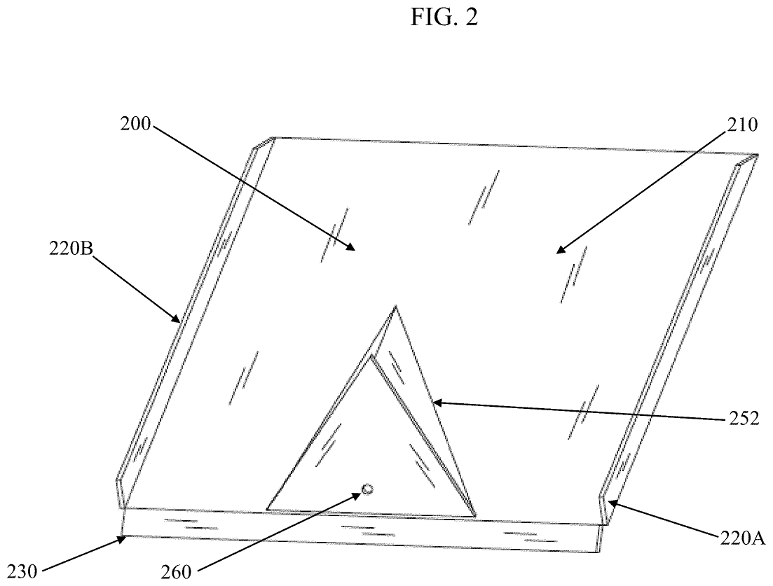

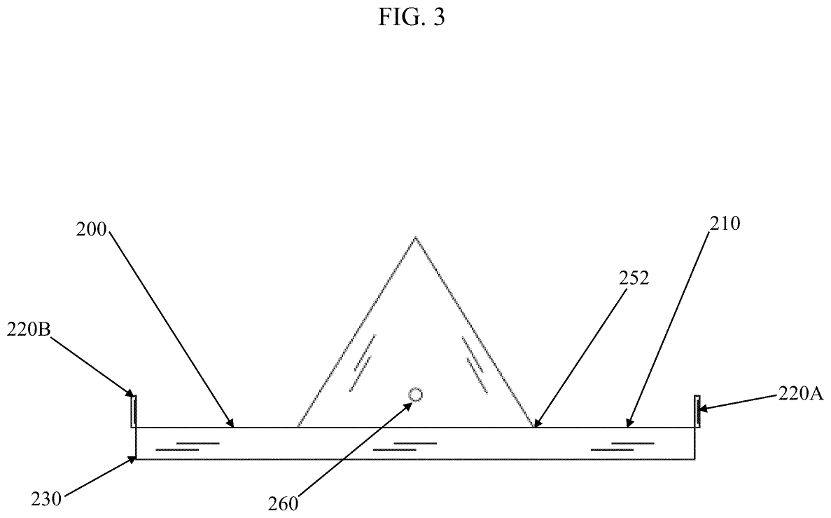

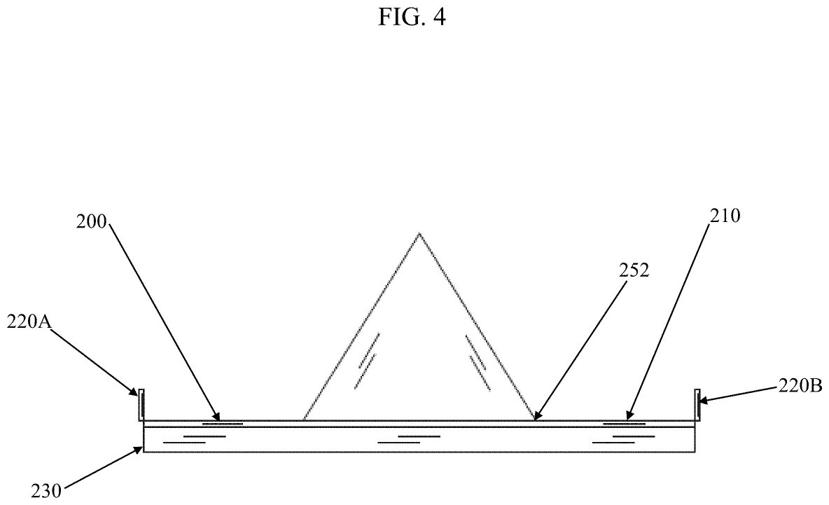

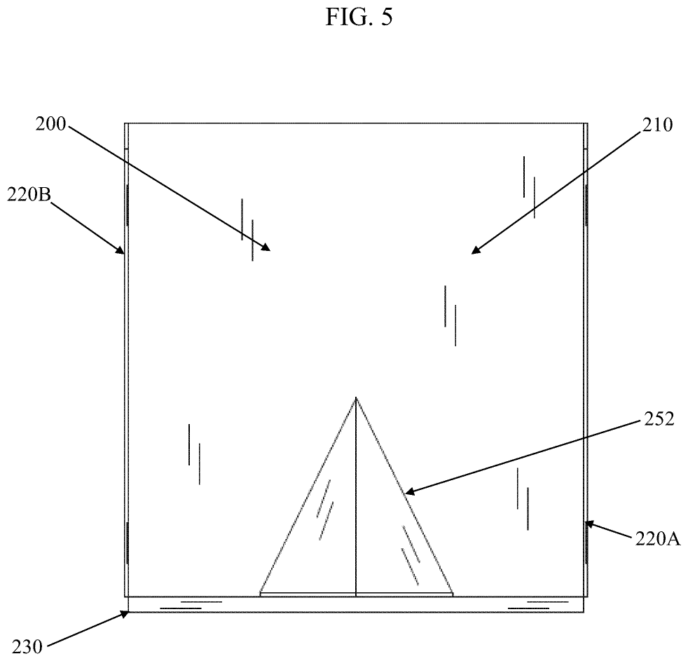

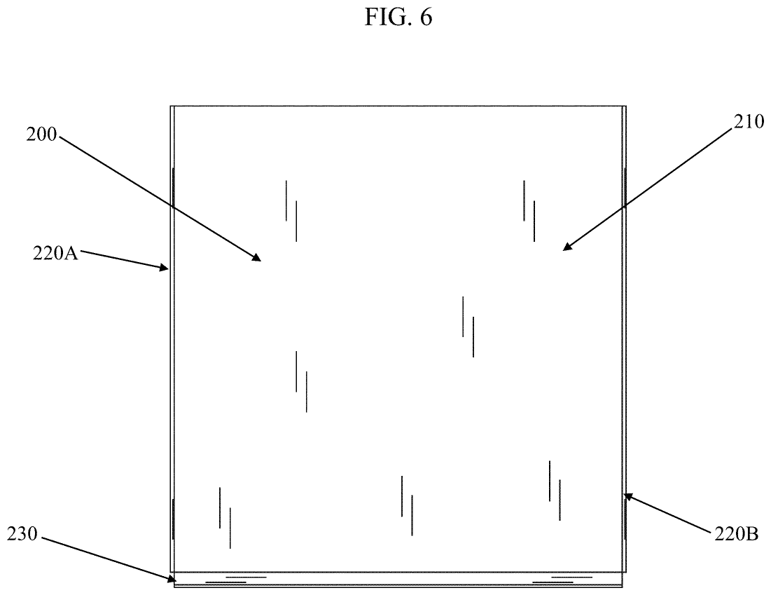

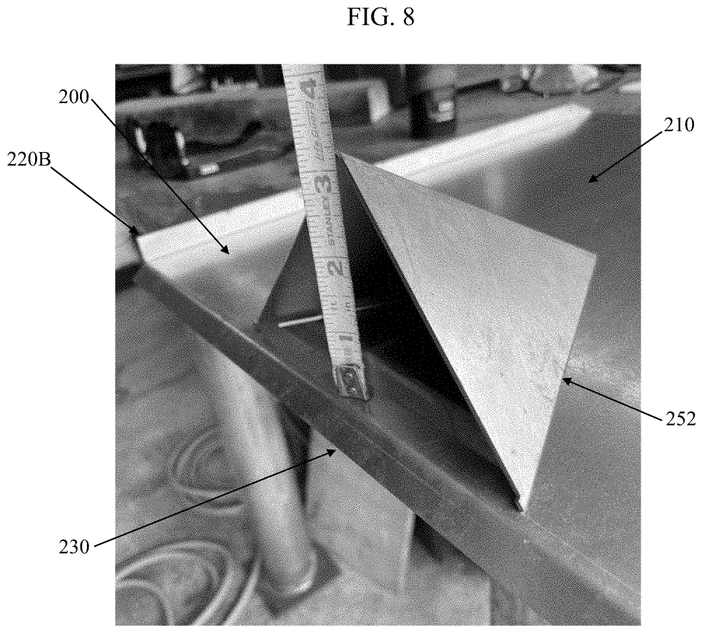

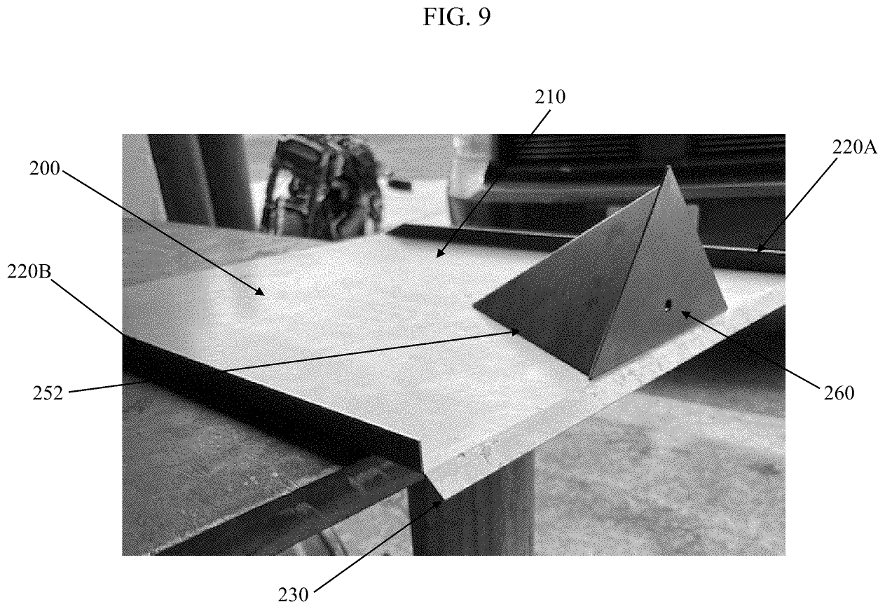

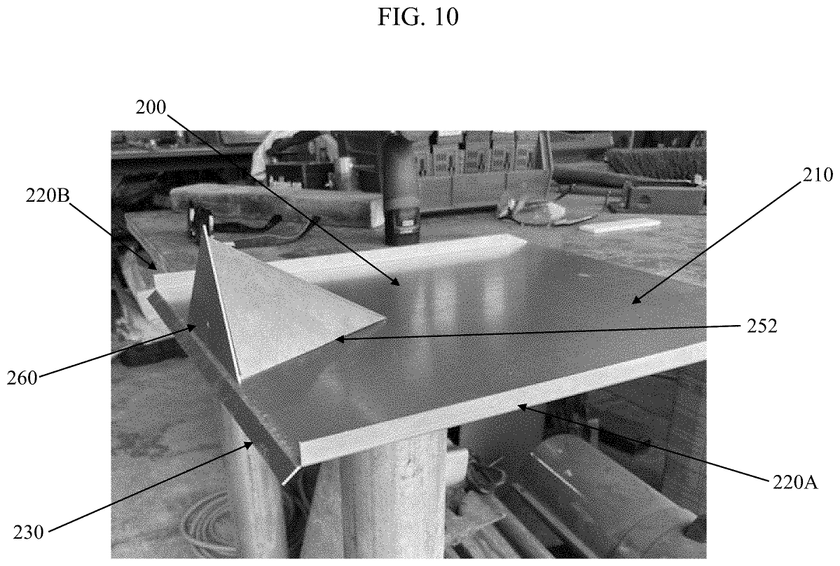

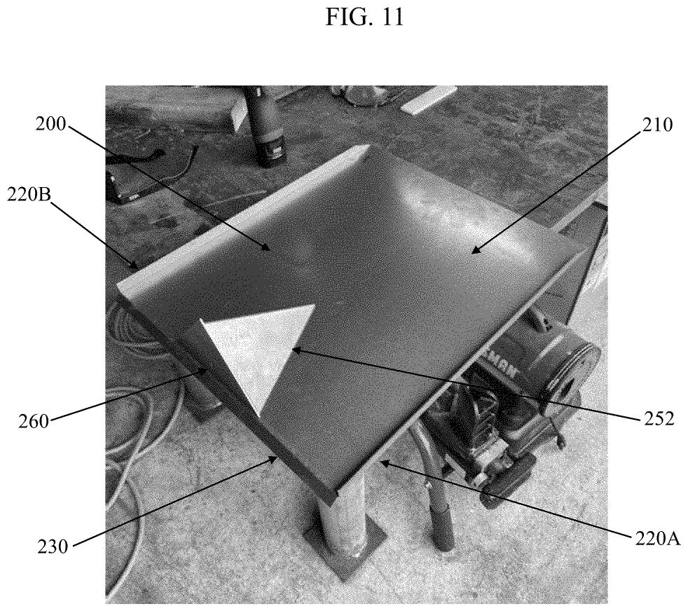

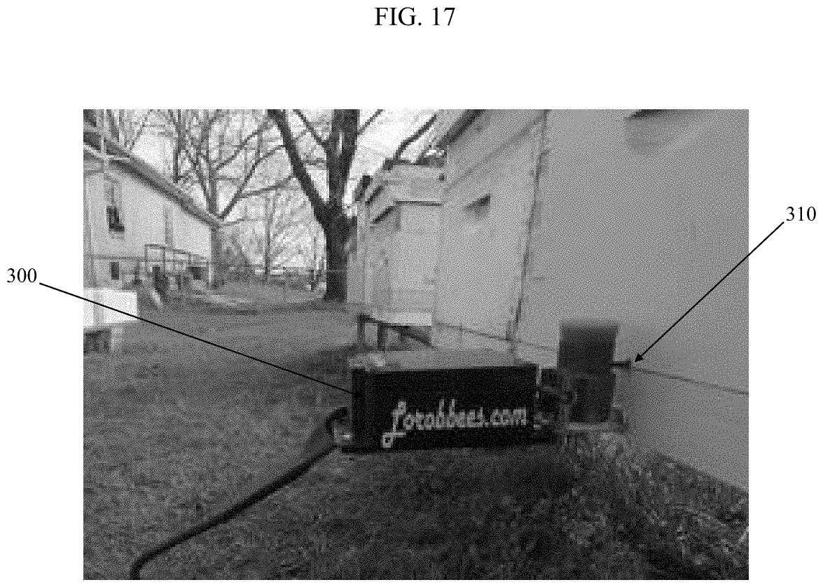

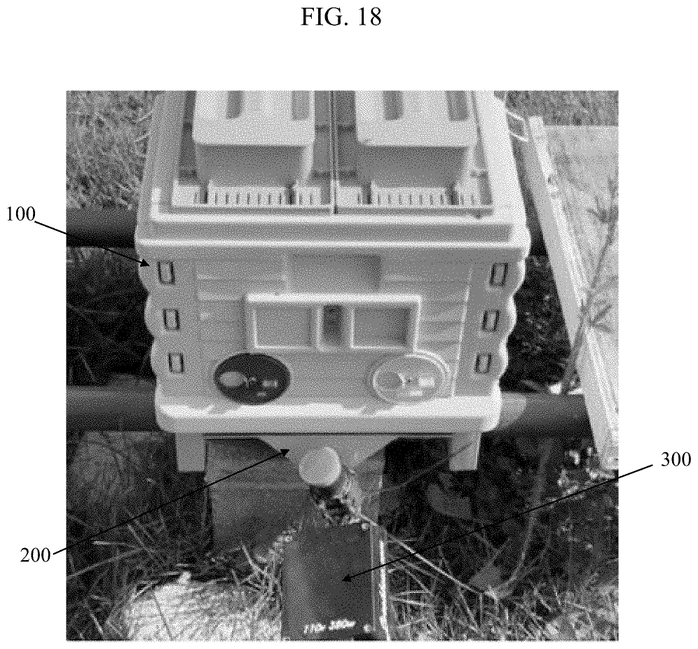

Referring now also to FIGS. 2-11, the adapter device 200 includes an adapter body 210 (e.g., a flat plate 210) having at least one hive engagement feature 220A,220B (e.g., side edges 220A,220B of the plate 210); at least one manipulation feature 230 (e.g., a lip 230 for gripping a front of the plate 210); and a recess 240 providing a reservoir 250 (e.g., a space for the hot acid vapor to gather) below the hive 100, the reservoir 250 being open to an interior of the hive 100, the recess 240 including a port 260 (e.g., a through hole 260) configured to accommodate a vaporizer output 310 (e.g., a tube 310) of a vaporizer 300 (see FIGS. 17 and 18).

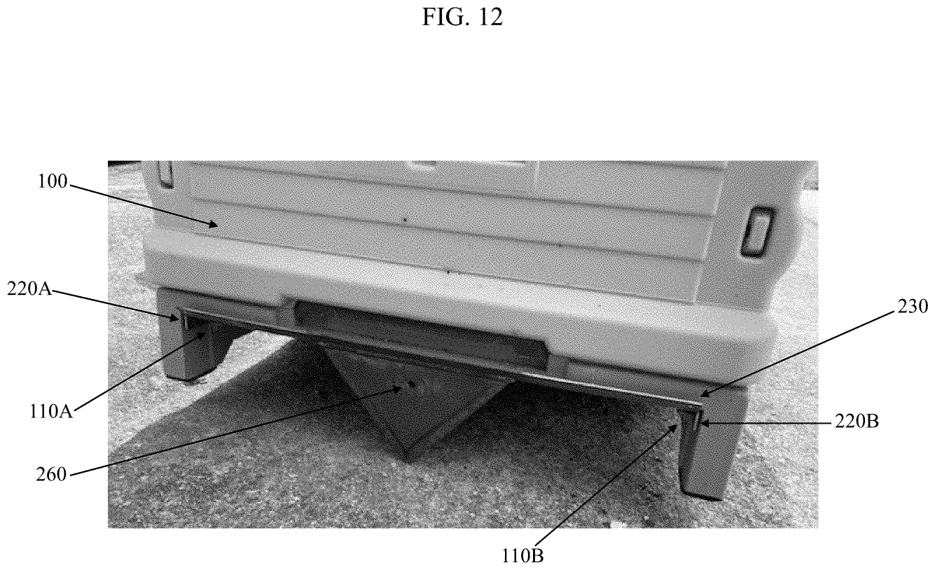

In example embodiments, the hive 100 has lateral protrusions 110A,110B (e.g., (e.g., ledges 110A,110B, best seen in FIG. 12), and the hive engagement feature 220A,220B includes lateral edges 220A,220B that slidably engage with the protrusions 110A,110B.

The protrusions 110A,110B extend inwardly (e.g., ledges 110A,110B extending inwardly from interior walls of the hive bottom), and the edges 220A,220B slide on the protrusions 110A,110B.

Further, the adapter body 210 is planar, the edges 220A,220B extend non-parallel to the adapter body 210 (e.g., bend downward relative to the body of the plate 210), and ends of the edges 220A,220B (e.g., downwardly extending ends of the edges 220A,220B) slide on the protrusions 110A,110B.

In example embodiments, the manipulation feature 230 includes a lip 230 that extends outwardly from the hive 100 (e.g., is outside the hive 100) when the device 200 is installed in the hive 100.

The adapter body 210 is planar and the lip 230 extends non-parallel to the body 210 (e.g., bends upwards and away from the body of the plate 210).

In example embodiments, the reservoir 250 has a pyramid shape with a base 252 of the pyramid shape being open to the interior of the hive 100.

The pyramid shape has a height of between 3 inches and 3.5 inches. However, the present general inventive concept is not limited thereto.

The pyramid shape is a triangular pyramid shape.

Further, a base 252 of the triangular pyramid shape is an isosceles triangle.

Still further, the isosceles triangle has a height of 5 inches and a width of about 5.0625 inches. However, the present general inventive concept is not limited thereto.

In example embodiments, the port 260 includes a hole 260 (e.g., a through hole 260) leading from an exterior surface of the recess 240 to an interior surface of the recess 240.

The hole has a diameter of between 0.15 inches and 0.45 inches. However, the present general inventive concept is not limited thereto.

### Beekeeping Device Embodiments

In other example embodiments of the present general inventive concept, the invention provides a beekeeping device that includes a hive body and a vaporizer adapter device.

Referring again to FIGS. 1, 12, 15 and 18, an example embodiment of a beekeeping device according to the present general inventive concept includes a hive body 100 and a vaporizer adapter device 200.

Referring again now to FIGS. 2-11, the adapter device 200 is removably installed in the hive body 100 and has an adapter body 210 (e.g., a flat plate 210) with at least one hive engagement feature 220A,220B (e.g., side edges 220A,220B of the plate 210), at least one manipulation feature 220A,220B, (e.g., a lip 230 for gripping a front of the plate 210) and a recess 240 providing a reservoir 250 (e.g., a space for the hot acid vapor to gather) below the hive body 100, the reservoir 250 being open to an interior of the hive body 100, the recess 240 including a port 260 (e.g., a through hole 260) configured to accommodate a vaporizer output 310 (e.g., a tube 310) of a vaporizer 300 (see again FIGS. 17 and 18).

In example embodiments, the hive body 100 has lateral protrusions 110A,110B (e.g., (e.g., ledges 110A,110B, best seen in FIG. 12), and the hive engagement feature 220A,220B includes lateral edges 220A,220B that slidably engage with the protrusions 110A,110B.

The protrusions 110A,110B extend inwardly (e.g., ledges 110A,110B extending inwardly from interior walls of the hive bottom), and the edges 220A,220B (e.g., downwardly extending ends of the edges 220A,220B) slide on the protrusions 110A,110B.

Further, the adapter body 210 is planar, the edges 220A,220B extend non-parallel to the adapter body 210 (e.g., bend downward relative to the body of the plate 210), and ends of the edges 220A,220B slide on the protrusions 110A,110B.

In example embodiments, the manipulation feature 230 includes a lip 230 that extends outwardly from the hive body 100 (e.g., is outside the hive 100) when the adapter device 200 is installed in the hive body 100.

The adapter body 210 is planar and the lip 230 extends non-parallel to the adapter body 210 (e.g., bends upwards and away from the body of the plate 210).

In example embodiments, the reservoir 250 has a pyramid shape with a base 252 of the pyramid shape being open to the interior of the hive body 100.

The pyramid shape has a height of between 3 inches and 3.5 inches.

The pyramid shape is a triangular pyramid shape.

Further, a base 252 of the triangular pyramid shape is an isosceles triangle.

Still further, the isosceles triangle has a height of 5 inches and a width of 5.0625.

In example embodiments, the port 260 includes a hole 260 (e.g., a through hole 260) leading from an exterior surface of the recess 240 to an interior surface of the recess 240.

The hole has a diameter of between 0.15 inches and 0.45 inches.

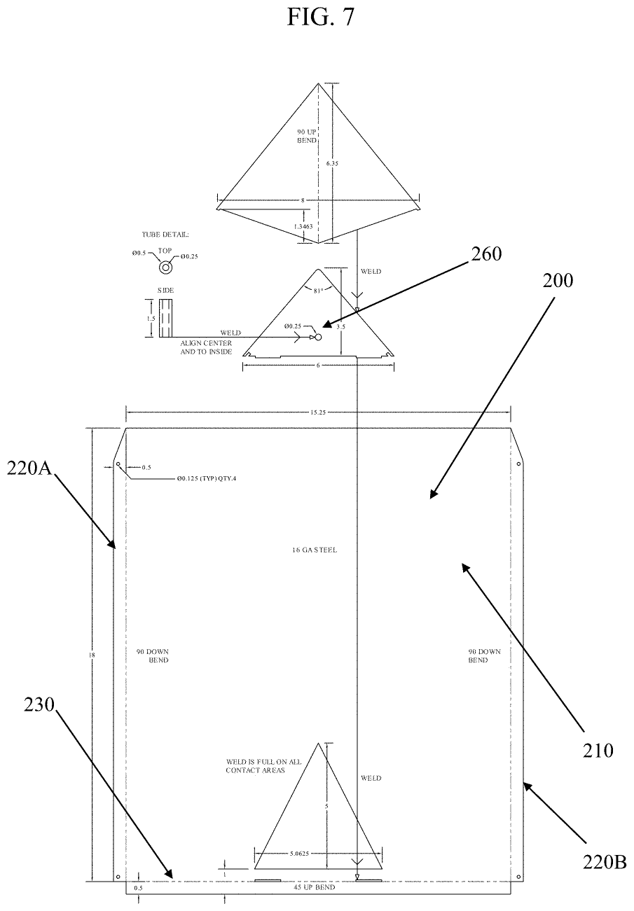

Example dimensions of certain aspects of the vaporizer adapter device 200 are illustrated and indicated on FIG. 7.

In operation, the vaporizer adapter device is installed by engaging the hive engagement feature of the adapter body with the hive using the hive manipulating feature to install the vaporizer adapter device in the hive such that the reservoir is open to an interior of the hive. Then, a vaporizer output of a vaporizer is passed through the port and the vaporizer is operated to apply the treatment such that the hot acid vapors gather in the reservoir and pass into the interior of the hive, killing any varroa mites.

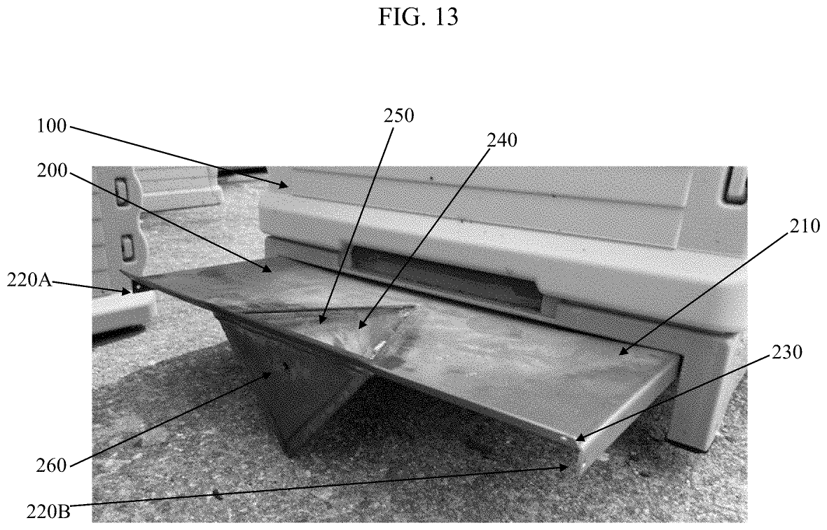

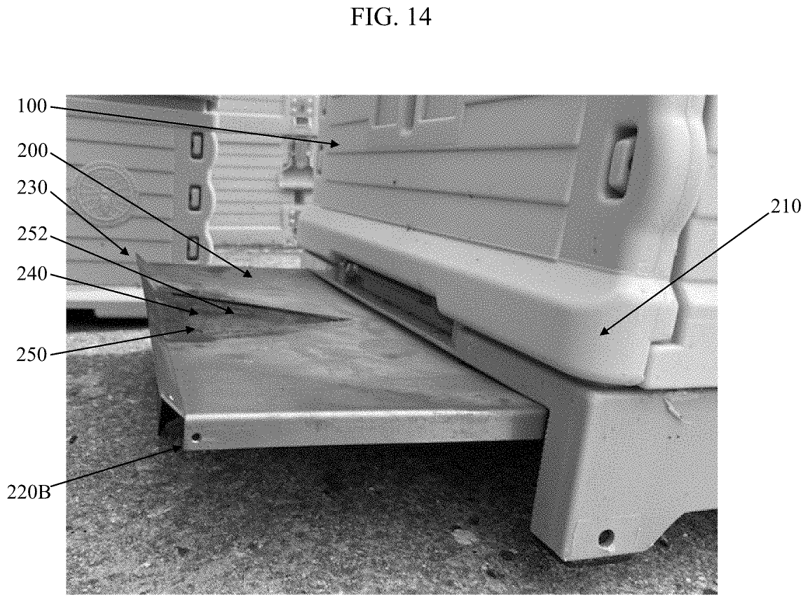

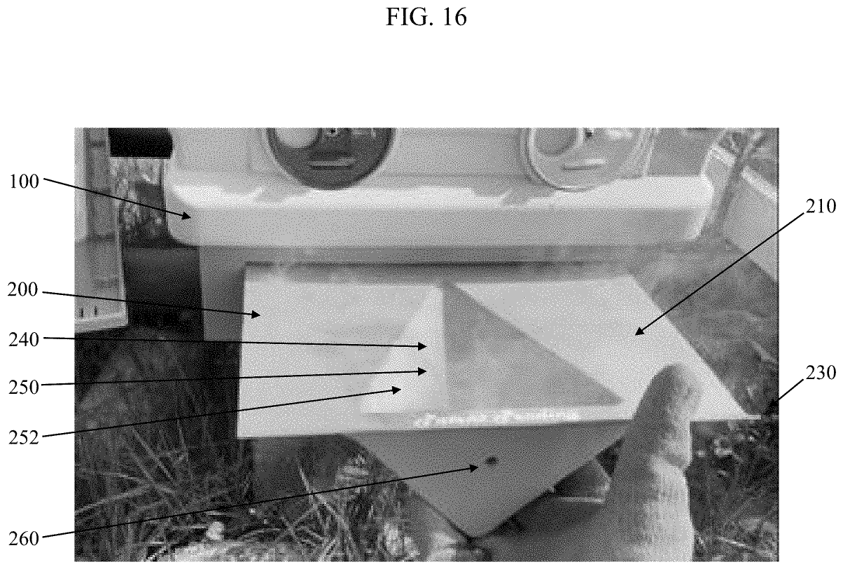

As an example operation, and referring now also to FIGS. 12-18, the vaporizer adapter device 200 is installed by sliding the lateral edges 220A,220B of the adapter plate 210 onto the lateral protrusions 110A,110B of the hive 100 using the lip 230 of the adapter plate 210 to install the vaporizer adapter device 200 in the hive 100 at the hive bottom such that the reservoir 250 is open from above to an interior of the hive 100. Then, the vaporizer output 310 of the vaporizer 300 is passed through the port 260 and the vaporizer 300 is operated to apply the treatment such that the hot acid vapors gather in the reservoir 250 and then pass upwardly into the interior of the hive 100, killing any varroa mites.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A vaporizer adapter device for a beekeeping hive, comprising:
an adapter body having
at least one hive engagement feature;
at least one manipulation feature; and
a recess providing a reservoir below the hive, the reservoir being open to an interior of the hive, the recess including a port configured to accommodate a vaporizer output.

2. The device of claim 1, wherein the hive has lateral protrusions, and the hive engagement feature includes lateral edges that slidably engage with the protrusions.

3. The device of claim 2, wherein the protrusions extend inwardly, and the edges slide on the protrusions.

4. The device of claim 3, wherein the adapter body is planar, the edges extend non-parallel to the adapter body, and ends of the edges slide on the protrusions.

5. The device of claim 1, wherein the manipulation feature includes a lip that extends outwardly from the hive when the device is installed in the hive.

6. The device of claim 5, wherein the adapter body is planar and the lip extends non-parallel to the body.

7. The device of claim 1, wherein the reservoir has a pyramid shape with a base of the pyramid shape being open to the interior of the hive.

8. The device of claim 7, wherein the pyramid shape is a triangular pyramid shape.

9. The device of claim 8, wherein a base of the triangular pyramid shape is an isosceles triangle.

10. The device of claim 1, wherein the port includes a hole leading from an exterior surface of the recess to an interior surface of the recess.

11. A beekeeping device comprising:
a hive body; and
a vaporizer adapter device; wherein
the device is removably installed in the hive body and has an adapter body with
at least one hive engagement feature;
at least one manipulation feature; and
a recess providing a reservoir below the hive body, the reservoir being open to an interior of the hive body, the recess including a port configured to accommodate a vaporizer output.

12. The device of claim 1, wherein the hive body has lateral protrusions, and the hive engagement feature includes lateral edges that slidably engage with the protrusions.

13. The device of claim 12, wherein the protrusions extend inwardly, and the edges slide on the protrusions.

14. The device of claim 13, wherein the adapter body is planar, the edges extend non-parallel to the adapter body, and ends of the edges slide on the protrusions.

15. The device of claim 1, wherein the manipulation feature includes a lip that extends outwardly from the hive body when the device is installed in the hive body.

16. The device of claim 15, wherein the adapter body is planar and the lip extends non-parallel to the body.

17. The device of claim 1, wherein the reservoir has a pyramid shape with a base of the pyramid shape being open to the interior of the hive body.

18. The device of claim 4, wherein the pyramid shape is a triangular pyramid shape.

19. The device of claim 18, wherein a base of the triangular pyramid shape is an isosceles triangle.

20. The device of claim 1, wherein the port includes a hole leading from an exterior surface of the recess to an interior surface of the recess.
